(19) United States
(12) Patent Application Publication
(10) Pub. No.: US 2014/0355292 A1
(43) Pub. Date: Dec. 4, 2014

(54) Fiber Optic Filament Lamp

(71) Applicant: Gabriel Krause, Brooklyn, NY (US)

(72) Inventor: Gabriel Krause, Brooklyn, NY (US)

(21) Appl. No.: 14/292,602

(22) Filed: May 30, 2014

Related U.S. Application Data
(60) Provisional application No. 61/829,116, filed on May 30, 2013.

(51) Int. Cl. F21K 99/00

(52) U.S. Cl. CPC F21K 9/52
USPC 362/555

(57) ABSTRACT

A fiber optic filament lamp is disclosed, which emulates the look and light characteristics of a vintage-style long filament incandescent lamp. The fiber optic filament lamp includes, but is not limited to, a plurality of optic filaments and at least one LED configured to direct light into an end of each of the plurality of optic filaments. Each optic filament is an optical fiber that has been treated such that light directed into the end of the filament is emitted from at least one lateral surface region of the filament. The at least one lateral surface region is configured to emit light having a substantially uniform luminous flux. In one embodiment, the lamp includes a second light emitting diode configured to direct light into a second end of each of the plurality of optic filaments.

### CROSS-REFERENCE TO RELATED APPLICATION

This application claims the benefit of and incorporates by reference in its entirety Applicant's U.S. provisional patent application Ser. No. 61/829,116 entitled “Fiber Optic Filament Lamp,” filed on May 30, 2013.

### FIELD OF THE INVENTION

The invention relates generally to illumination devices using light-emitting diodes and more particularly to a fiber optic filament lamp.

### BACKGROUND

Incandescent lamps typically include an incandescent filament within a glass enclosure. Incandescent filaments are fragile and tend to degrade during the lifetime of a lamp. The average life expectancy of an incandescent lamp is about 2,500 hours. Incandescent lamps also use a lot of power and are inefficient, as much of the power used does not go to generating light but is lost through heat. Typical incandescent lamps are power-rated in the range of 40-100 Watts and efficiency-rated around 15 lumens per Watt. Typical incandescent lamps have filaments that range from 3 centimeters to 7 centimeters in length. Long filament vintage-style lamps are becoming increasingly popular because of their aesthetic appeal. Vintage-style lamps have compounding inefficiencies due to the relatively low temperature operation of their filaments and only produce efficiencies of 3 lumens per Watt or lower. Vintage-style lamps typically have filaments that range from 12 centimeters to 56 centimeters in length.

Though inefficient, incandescent lamps and the warm light that they emit have an aesthetic appeal to users. Current alternatives to incandescent lamps such as compact fluorescent lamps use less power and last longer, but have a very different shape and light quality from traditional lamps that many users do not find aesthetically pleasing. Some users still prefer the look of the bulb shape and exposed filament of vintage-style lamps, particularly for use in light fixtures where the entirety of the lamp is visible. Any further reference herein to either a conventional or vintage-style incandescent lamp shall also imply a clear glass bulb enclosure where the incandescent filaments are visible.

As a light source, light emitting diodes (LEDs) are more efficient than incandescent lamps. Currently, a LED has an expected lifespan of tens of thousands of hours, is about four times more efficient than a conventional incandescent lamp, and is about twenty times more efficient than a vintage-style long filament incandescent lamp. LEDs are twice as efficient as a compact fluorescent lamp. LEDs are also not as susceptible to damage as incandescent lamps, being very resistant to vibration and impacts. Unlike compact fluorescent lamps, LEDs do not contain mercury. Many LED light fixtures also produce directional light, which may not be desirable in all environments.

One prior art type of LED light fixture is disclosed in U.S. Pat. No. 7,810,974. That light source includes an LED and one or more spirally-wound optical fibers. A drawback of a spirally-wound optical fiber is that in forming the spiral shape the fiber is subjected to persistent bending, generally known as “macro-bending.” When an optical fiber is bent at a radius smaller than the minimum bending radius specified by the fiber manufacturer, light will escape from the lateral surfaces of the fiber near the bend. Macro-bending is usually avoided for efficient light transmission through optical fibers. While macro-bending an optical fiber to form a spiral portion will cause light to be released from the lateral surface of the fiber in the spiral portion, that light emission from the spiral portion is not uniform. Macro-bending at any specific radius will always release the most light at an end of the spiral portion closest to the light source and the intensity of the emitted light progressively attenuates as the light travels further from the light source.

Modern non-LED light bulbs have benefited from technological advances in electric filament design such that short lengths of filament are typical. Thus a short optical fiber length may suffice when replicating a modern-style electric light bulb with an LED light source. Traditional-style long filament light bulbs are manufactured with filament lengths that are typically greater than 18 centimeters, and have a uniform light output along the entire length of the filaments. To achieve a similar uniform light output along an optical fiber of similar length in an LED light bulb would require a carefully designed fiber treatment that takes into consideration the length of the treated fiber, the diameter of the fiber optic, the numerical aperture of the fiber optic, the number of LED light sources, and the intensity of the light emitted by each LED light source.

Thus there is a need for a highly efficient illumination device that emulates the look and light characteristics of a vintage-style long filament incandescent lamp.

### SUMMARY

A fiber optic filament lamp is disclosed, which emulates the look and light characteristics of a long filament incandescent lamp. The fiber optic filament lamp includes, but is not limited to, a plurality of optic filaments and at least one LED configured to direct light into an end of each of the plurality of optic filaments. Each optic filament is an optical fiber having at least one lateral surface region configured to emit light of substantially uniform luminous flux. In one embodiment, each optic filament is at least approximately eight centimeters in length. The plurality of optic filaments emit multi-directional light similar to the light emitted by a traditional incandescent lamp. The optic filament lamp may also include a filament support that secures the plurality of optic filaments in a predetermined position. In one embodiment, the fiber optic filament lamp includes a second light emitting diode configured to direct light into a second end of each of the plurality of optic filaments.

In one embodiment, each of the plurality of optic filaments has been treated using a mechanical or chemical process such that light directed into the end of the optic filament will be emitted from one or more lateral surface regions of the fiber. The treatment process is applied to the optic filament in a non-linear progression. A subtractive mechanical process may be scoring longitudinal grooves into the outer surface of an optic filament or may be scoring or etching a spiral groove or other pattern around and along the outer surface of the optic filament. The scoring or etching process may be applied in a variety of ways, such as using a laser-etching device to imprint the desired pattern on the surface of the optic filament. In another embodiment, each of the plurality of optic filaments has been treated using a chemical process such that light directed into the end of the optic filament will be emitted from one or more lateral surface regions of the fiber. A subtractive chemical process may be immersing the optic filament in a liquid chemical bath, exposing the optic filament to a chemical gas, or using an atomized fluid technique to etch a gradation of texture or a pattern of varying depths to the optic filament surface. Additive processes may be to bond a fine strand of opaque material to the optic filament, to bond a fine thread of transparent material with a different index of refraction to the optic filament, or to form solidified droplets of an optically transmissive material on the surface of the optic filament or to apply a phosphor coating to the surface of the filament. A manipulative process may be to direct a finely focused laser into the optic filament to create instances of internal cavitation. A combination of techniques may be used, for example application of a chemical solvent to a mechanically-scored filament to produce a smooth surface in desired areas of the lateral surface of the optic filament.

In one embodiment, the fiber optic filament lamp further includes a translucent or transparent housing that encloses the plurality of optic filaments and at least one LED. The housing may have a shape that emulates the shape of a traditional incandescent lamp. The fiber optic filament lamp may also have a base configured to fit commercially-available light fixtures that also accept standard incandescent lamps.

### BRIEF DESCRIPTION OF THE DRAWINGS

FIG. 1 is a diagram of one embodiment of an optic filament lamp;

FIG. 2A is a diagram of a portion of one embodiment of an optic filament lamp;

FIG. 2B is a diagram of a portion of another embodiment of an optic filament lamp;

FIG. 3 is a diagram of one embodiment of an optic filament with treated regions;

FIG. 4 is a diagram of another embodiment of an optic filament with treated regions;

FIG. 5 is a diagram of another embodiment of an optic filament with treated regions;

FIG. 6 is a diagram of another embodiment of an optic filament with treated regions;

FIG. 7 is a diagram of another embodiment of an optic filament with treated regions; and

FIG. 8 is a diagram of another embodiment of an optic filament with treated regions.

### DETAILED DESCRIPTION

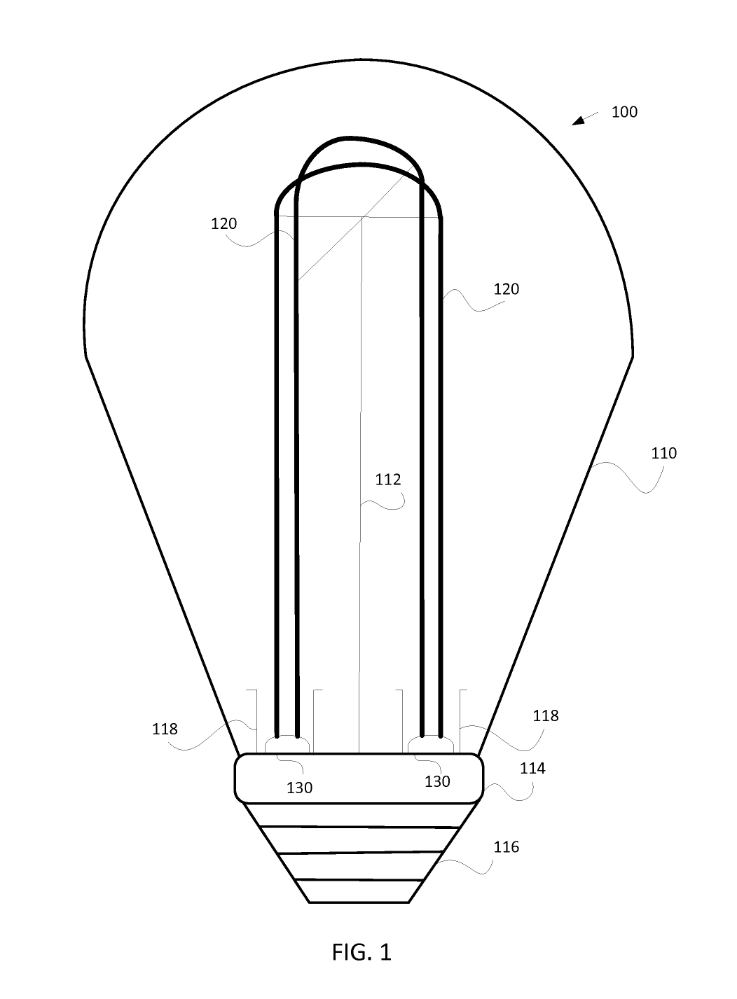

FIG. 1 is a diagram of one embodiment of an optic filament lamp 100. Lamp 100 includes, but is not limited to, an outer shell (or housing) 110, a filament support 112, a platform 114, a base 116, and filament aligner 118. Lamp 100 also includes optic filaments 120, which are supported by filament support 112. Two light emitting diodes (LEDs) 130 direct light into the ends of optic filaments 120. In other embodiments, light from an LED may be directed into only one end of an optic filament 120. FIG. 1 shows lamp 100 as having two optic filaments 120 and two LEDs 130. In other embodiments, lamp 100 includes any number of optical filaments 120 and any number of LEDs 130. Filament aligner 118 assists in aligning optical filaments 120 with LEDs 130. Lamp 100 is configured to look similar to a long tungsten filament incandescent lamp and to produce light similar to the light produced by a long filament incandescent lamp.

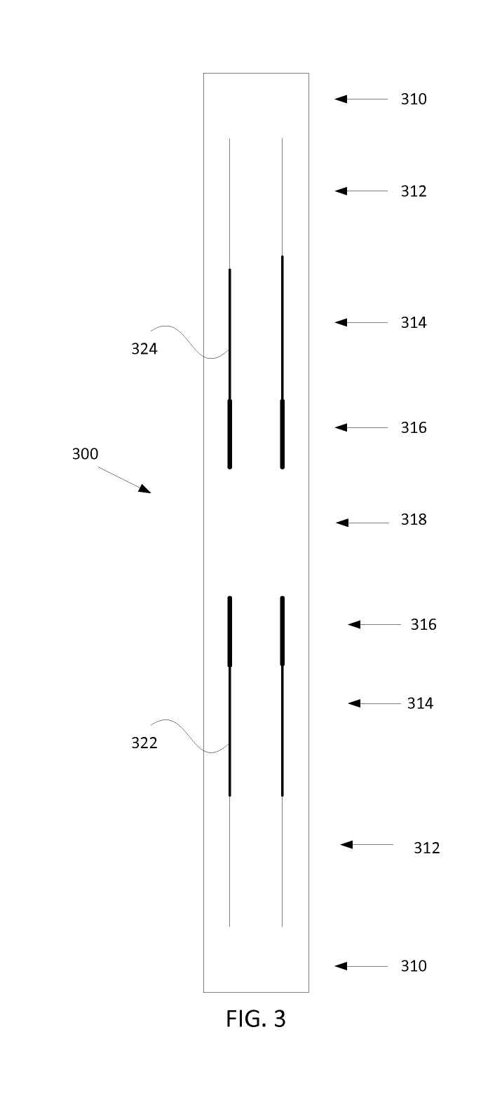

Optic filaments 120 are optical fiber filaments that are configured to accept light at the fiber ends. Unlike standard optical fibers, which are configured to release a minimal amount of light from the lateral surfaces of the fiber, each of optic filaments 120 have been conditioned or treated so that light entering the filament from LED 130 is released from one or more regions of the lateral surface of optic filaments 120 at a substantially uniform flux. Any of optic filaments 120 may have a single region conditioned or multiple regions conditioned. Each of optic filaments 120 are configured such that light is emitted substantially uniformly among the conditioned regions of the filament. Techniques for conditioning optic filaments 120 are described below in conjunction with FIGS. 3-8. Optic filaments 120 are preferably three millimeters or less in diameter and at least approximately 8 centimeters long. In one embodiment, each of optic filaments 120 includes a treated lateral surface region that is at least about 12 centimeters in length.

Outer shell (or housing) 110 is shown having a traditional lamp shape, but outer shell 110 can have any shape including, but not limited to, spherical, cylindrical, elliptical, domed, squared, or rectangular. In one embodiment, outer shell 110 has a conic cross-sectional shape that optimizes directional reflection of an internal light source. Outer shell 110 may be made of glass, polycarbonate, acrylic, nylon, or any other solid translucent or transparent material. The material of outer shell 110 may vary in thickness to create a lens effect. Outer shell 110 may be tinted to augment the color of lamp 100, or may be completely or partially mirrored to accentuate reflective patterns. In other embodiments of lamp 100 an outer shell 110 is not included.

In one embodiment, outer shell 110 is removable from platform 114 and re-attachable to platform 114. As LEDs are long-lasting light sources, if outer shell 110 is broken or damaged it is likely that lamp 100 would still be operational. Outer shell 110 may connect to platform 114 using a threaded ring connection, a twist-lock connection, a snap-in connection, or any other type of connection that enables outer shell 110 to be removed from lamp 100 and a replacement outer shell 110 connected to lamp 100.

As shown in FIG. 1, filament support 112 supports optic filaments 120 in the shape of two loops. Filament support 112 may be made of wire; laser cut, formed, or machined sheet metal or plastic; injection-molded plastic; or die case metal. Filament support 112 may be flexible to resist damage due to handling of lamp 100 or to make assembly of lamp 100 easier. In other embodiments, filament support 112 holds optic filaments 120 in a chosen pattern including but not limited to a parallel cage, a zig-zag cage, a circle, concentric shapes, arrayed shapes, polygonal shapes, a funnel-shape, a shape that conforms to the contours of outer shell 110, a shape that mimics the shape of an outer shell or housing, or a combination of such shapes. In another embodiment, lamp 100 does not include filament support 112 and optic filaments 120 are interwoven or otherwise configured to provide self-support.

In one embodiment, platform 114 includes a heat sink (not shown). A heat sink dissipates thermal energy from LEDs 130 and power conversion circuit components (not shown). The heat sink is constructed from any material capable of conducting heat away from LEDs 130 power conversion circuit components. The size of the heat sink will depend on the power rating (wattage) and number of LEDs in lamp 100. For some embodiments of lamp 100, the materials making up platform 114 and base 116 may be sufficient to dissipate the heat generated by LEDs 130 without a separate heat sink. Other structures of lamp 100 may also function as heat dissipaters, for example filament support 112, filament aligner 118, base 116, and a connector that enables removal and attachment of outer shell 110 to lamp 100. Lamp 100 may also include orifices to provide airflow that may assist with heat dissipation.

Base 116 is configured to mount into conventional commercially-available lamp sockets so that lamp 100 may be easily used in lieu of a traditional incandescent lamp or compact fluorescent lamp. Base 116 includes an electric power conversion circuit (not shown) that converts a standard domestic 120V AC or international 220V AC voltage to provide a direct current (DC) power signal to LEDs 130. Base 116 may include an electric power conversion circuit that converts a 12V DC voltage to provide an appropriate power signal to LEDs 130. In other embodiments, the power conversion circuit may also be fully or partially housed in or on platform 114. In other embodiment, LEDs 130 may be configured as part of an AC LED module that integrates the power conversion circuit within the LED module.

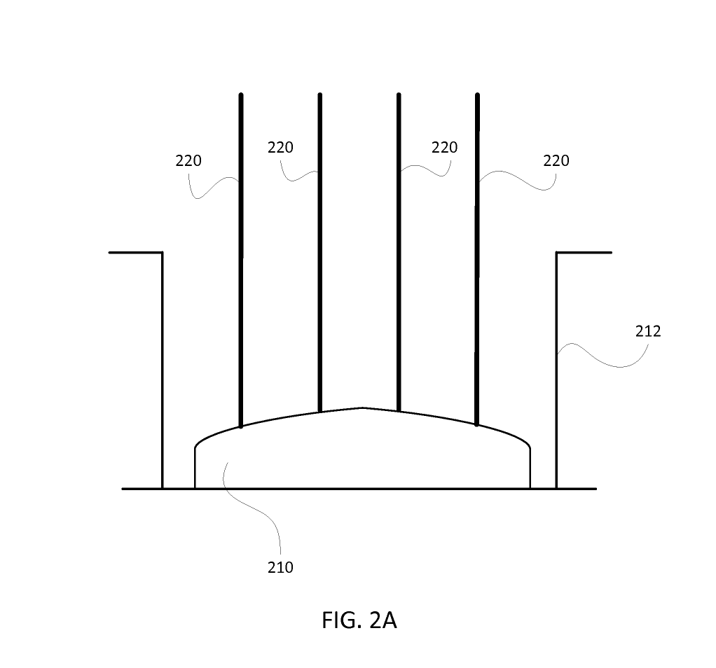

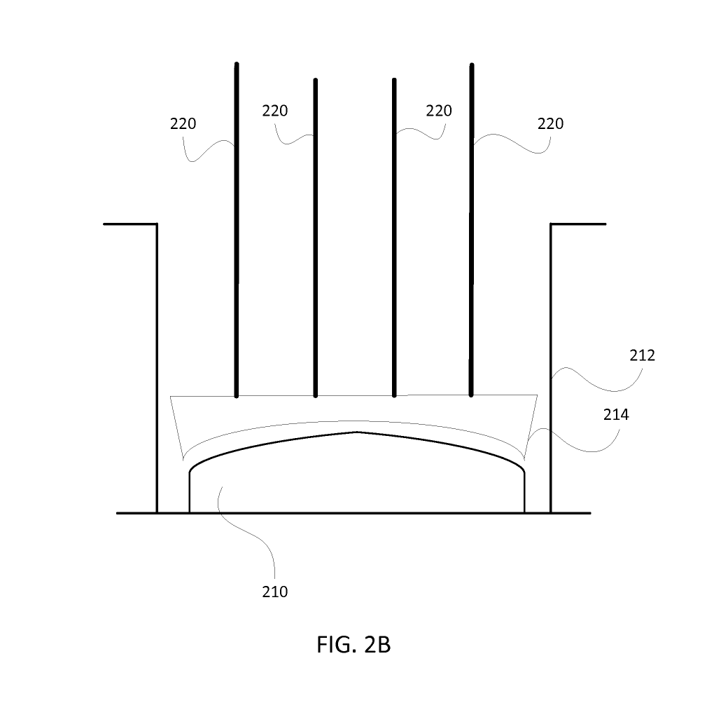

FIG. 2A is a diagram of a portion of one embodiment of an optic filament lamp. In the FIG. 2A embodiment, four optic filaments 220 accept light from an LED 210. Filament aligner 212 assists in positioning the ends of optic filaments 220 so as to accept light from LED 210. Optic filaments 220 are arranged on LED 210 to effectively direct light into the ends of the filaments. Various algorithms can be used to optimize the arrangement of optic filaments 220 onto LED 210 depending on the particular geometry of the LED. The selected algorithm should maximize the transfer of light from an LED to ends of optic filaments specific to the geometries of the LED die, lens shape, and the diameter and number of optic filaments. In one embodiment, optic filaments 220 are arranged using a closest-circle packing algorithm, which positions ends of optic filaments onto an LED with a domed-shaped lens to maximize the light captured from the LED.

An interface (not shown) joins optic filaments 220 to LED 210, and may function to align the ends of optic filaments 220 to LED 210 or an optional optic collimator or concentrator. For example, an optical adhesive may be used to “glue” the ends of optic filaments 220 directly to the lens surface of LED 210. In another embodiment, the interface diffuses and blends the input of multiple LEDs of differing color correlated temperatures (CCT) into the ends of optic filaments 220. A CCT value in the range of 2700-3000K is described as “warm white,” a CCT value in the range of 3500-4000K is described as “neutral white,” and a CCT value in the range of 4500-5500K is described as “cool white.” Without blending, optic filaments receiving light from different colored LEDs would have a distinctly different color. In some embodiments, distinctly colored optic filaments may be desired. Independent LEDs of multiple colors allow for the control of color temperature (“cool” versus “warm” colors) and intensity, so that emulation of an incandescent lamp being dimmed is possible. A blending interface may be a diffusion panel. In another embodiment, blending may be achieved using braided strands of smaller-diameter optic filaments. Each braided strand of optic filaments would receive light from one LED of a certain color, and would be separated into its constituent filaments that are then interwoven with filaments from other braided strands receiving light of a different color to create a custom blend of color emitted by lamp 100. In other embodiments, the interface may be an optic coupler, an optic adaptor, or a flange mount coupler/adaptor.

A blind may be used to absorb light overflow at the LED 210 to optic filament 220 interface. Any light emerging from anywhere other than the one or more treated lateral surface regions optic filaments 220 will reduce the perceived emulation of the lamp as a traditional incandescent lamp. In one embodiment, the blind (not shown) is a thin, opaque film with holes where optic filaments 220 pass through.

LEDs typically have an integrated lens that serves two purposes: to protect the die and to distribute the emitted light in a pre-determined pattern. LED 210 may be customized with an optimally-shaped lens to accommodate the specific combined diameter of optic filaments 220 and to direct light optimally. A customized LED may be obtained from an LED manufacturer. Alternatively, the lens may be customized by melting the lens into a shape with a hot forming tool or shaving the lens down with a cutting tool.

Light source collimators or concentrators may be used to maximize narrow angle entry of light into the ends of optic filaments 220. Narrow angles of light entry increase transmission of light axially along optical fibers and reduce unintentional light escape from the lateral sides of optical fibers. An optic collimator “shapes” the emission of a point light source so that light emerges in a column of parallel aligned light rays. An optic concentrator directs all emissions from a light source to a point of focus. FIG. 2B is a diagram of a portion of another embodiment of an optic filament lamp that includes an optic collimator 214. Optic collimator 214 shapes the light from LED 210 into a column of parallel aligned light rays that are directed into the ends of optic filaments 220. By narrowing the angles of light entry into optic filaments 220, optic collimator 214 decreases unwanted light emission from untreated regions of the lateral surfaces of optic filaments 220. Optic collimator 214 may be implemented using a non-dome-shaped clear plastic lens, a reflector, or a combination of a lens and reflector.

Returning to FIG. 1, optic filaments 120 receive light at the filament ends from LEDs 130 and emit light from treated regions along their lateral surfaces. Disruptions in the surface of an optic filament 120 cause light to escape laterally, which in turn causes an attenuation of light traveling axially through optic filament 120. Optic filaments 120 have been treated such that the light intensity emitted from the lateral surface regions is substantially the same over the treated regions of the filaments. Light emitted from a treated region of optic filament 120 will cause attenuation of the light traveling axially along the filament. Light emission from treated regions of optic filament 120 is balanced by varying the surface treatment from a minimum treatment near a light source to a maximum treatment at a predetermined distance away from the light source. The treatment gradation is varied so that light intensity appears substantially uniform across the entire surface of optic filament 120. The surface of optic filament 120 can be treated using either subtractive, additive, or manipulative mechanical or chemical techniques including but not limited to scoring, notching, etching, internal disruption, introduction of an opaque medium, or introduction of a medium having a different index of refraction that the optical filament. A mathematical model may be used to calculate the resulting light intensity of any treatment technique by linear distance from a light source to achieve a variety of effects such as an even light intensity (luminous flux) from the entire surface of the filament, or uneven or varied light intensity from the surface of the filament in a regular, random, or organic pattern.

FIG. 3 is a diagram of one embodiment of an optic filament 300 that has been conditioned to emit light from specific regions along its lateral surface and is configured to accept light from a light source at both ends. In the FIG. 3 embodiment, the treatment comprises scoring fine grooves into optic filament 300 that are parallel to the longitudinal axis of optic filament 300. In FIG. 3 the thickness of the groove represents relative depth for illustration purposes only, as each groove has substantially the same width. Optic filament 300 also includes untreated regions 310 at the ends of the filament and an untreated region 318 at the middle of the filament. A first groove 322 is shallow in a region 312 near the end of optic filament 300, becomes deeper in a region 314, and then is at its deepest in a region 316 nearer to the middle of optic filament 300. Groove 322 ends before it reaches untreated region 318 at the middle of optic filament 300. A second groove 324 mirrors the first groove, the second groove 324 having its deepest region 316 nearer to the middle of optic filament 300 and then reducing in depth as it extends toward the other end of optic filament 300. Generally this longitudinal scoring technique applies fine scoring lightly near one end, intended to accept light from a light source, that gradually deepens as distance from the light source increases. When light is input into the ends of optic filament 300, light is emitted from treated regions 312, 314, and 316 of optic filament 300 at a substantially uniform luminous flux. The untreated middle region 318 internally reflects any light that reaches it after traveling from the ends of optic filament 300.

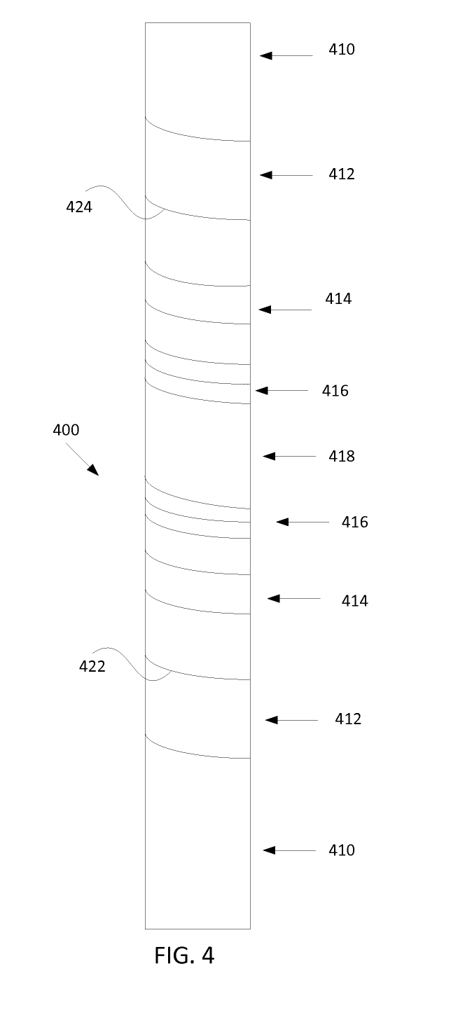

FIG. 4 is a diagram of another embodiment of an optic filament 400 that has been conditioned to emit light from specific regions of its lateral surface and is configured to accept light from a light source at both ends. A first spiral groove 422 of uniform depth has been scored into the surface of optic filament 400 in a spiral fashion. The pitch of the spiral is sparse in a region 412 near the end of optic filament 400 and becomes increasingly tighter in regions 414 and 416 toward the middle of optic filament 400 (as distance increases from the light source). Groove 422 ends before it reaches a middle region 418 of optic filament 400. A second spiral groove 424 of uniform depth has been scored into the surface of optic filament 400. The pitch of the spiral of groove 424 is tight in a region 416 near the middle portion 418 of optic filament 400 and becomes more sparse in regions 414 and 412 moving toward the end of optic filament 400. Optic filament 400 also includes untreated regions 410 at the ends of the filament and an untreated region 418 at the middle of the filament. When light is input into the ends of optic filament 400, light is emitted from treated regions 412, 414, and 416 of optic filament 400 at a substantially uniform luminous flux. The untreated middle region 418 internally reflects any light that reaches it after traveling from the ends of optic filament 400.

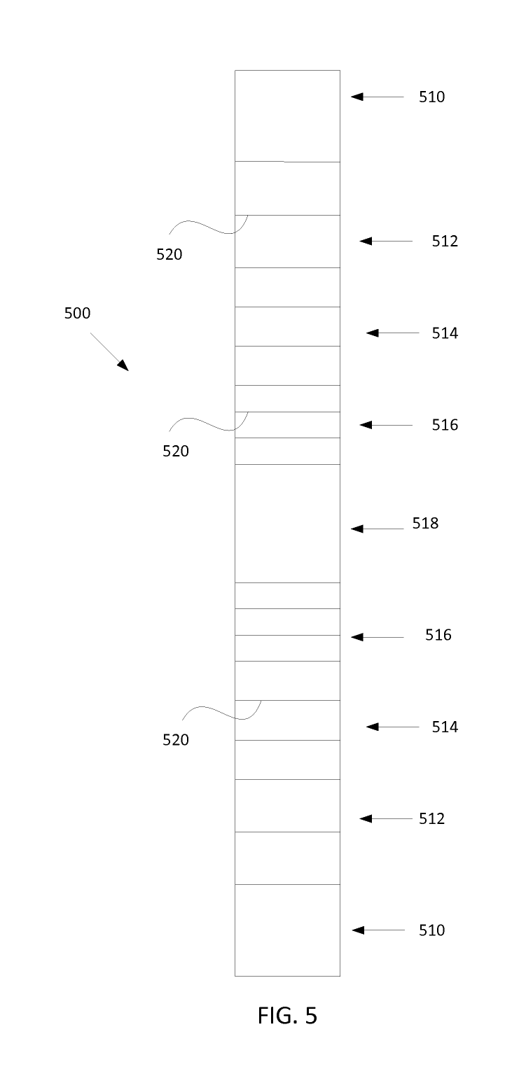

FIG. 5 is a diagram of another embodiment of an optic filament 500 that has been conditioned to emit light from specific regions of its lateral surface and is configured to accept light from a light source at both ends. Optic filament 500 has been conditioned with fine grooves 520 scored into the surface of the filament perpendicular to the longitudinal axis of the filament. The grooves 520 are substantially the same depth, but the distance between the grooves is greater in regions 512 near the end of optic filament 500, and then becomes progressively smaller in regions 514 and 516 moving toward the middle of optic filament 500. Optic filament 500 also includes untreated regions 510 at the ends of the filament and an untreated region 518 at the middle of the filament. When light is input into the ends of optic filament 500, light is emitted from treated regions 512, 514, and 516 of optic filament 500 at a substantially uniform luminous flux. The untreated middle region 518 internally reflects any light that reaches it after traveling from the ends of optic filament 500.

In another embodiment (not shown), an optic filament is conditioned with grooves scored into the surface of the filament perpendicular to the longitudinal axis of the filament, where the grooves are evenly spaced within the treated regions, and are shallow in regions near the ends of the optic filament and then become progressively deeper in regions closer to the middle of the optic filament.

In another embodiment, a liquid chemical bath can be used to modify the surface of an optic filament with an etching effect that increases along the length of the optic filament from an end or ends intended to accept light. The chemical bath can be composed of a concentration gradient that interacts with the surface of the optic filament accordingly. In a fixed concentration chemical bath, the optic filament can be progressively immersed over time so that surface etching time varies along the length of the filament.

In another embodiment, the optic filament is exposed to atomized airborne chemicals that etch the surface of the filament where the density of the atomized chemicals correlates to the amount of light release desired. In other embodiments, an optic filament may be exposed to chemical gas concentrations that are varied non-linearly or by exposure time along the length of the filament.

In another embodiment, a uniformly scored filament is immersed in a liquid chemical bath to modify the surface of the optic filament with a smoothing effect that decreases along the length of the optic filament from an end or ends intended to accept light. The chemical bath can be composed of a concentration gradient that interacts with the surface of the optic filament accordingly. In a fixed concentration chemical bath, the optic filament can be progressively immersed over time so that surface etching time varies along the length of the filament.

In another embodiment, a uniformly scored optic filament is exposed to atomized airborne chemicals that smooth the surface of the optic filament where the density of the atomized chemicals correlates to the amount of light release desired. In other embodiments, an optic filament may be exposed to chemical gas concentrations that are varied linearly or by exposure time along the length of the filament.

In another embodiment, a uniformly scored filament is exposed to heat at variable temperatures or durations to achieve a desired smoothing effect that is concentrated at the ends of the filament.

In another embodiment, an optic filament may be treated using an atomized fluid technique. Droplets of an atomized fluid would collect on the surface of the optic filament and then solidify on the surface. Droplets of an optically transmissive material will disrupt the internal flow of light within an optic filament. Rather than reflect off the filament walls internally, light that encounters a surface droplet will continue into the droplet and escape the surface due to variations in the material's index of refraction and incidence angle. Various methods of fixing droplets onto an optic filament include, but are not limited to, using a fluid that contains volatile agents that cure into a solid state; applying a fluid, which solidifies at atmospheric pressure, in a low pressure environment when it is liquid; applying a fluid, which solidifies at room temperatures, in a high temperature environment when it is liquid; or a combination of volatile agents, pressure, and temperature to apply atomized fluid droplets that will solidify under standard atmospheric conditions.

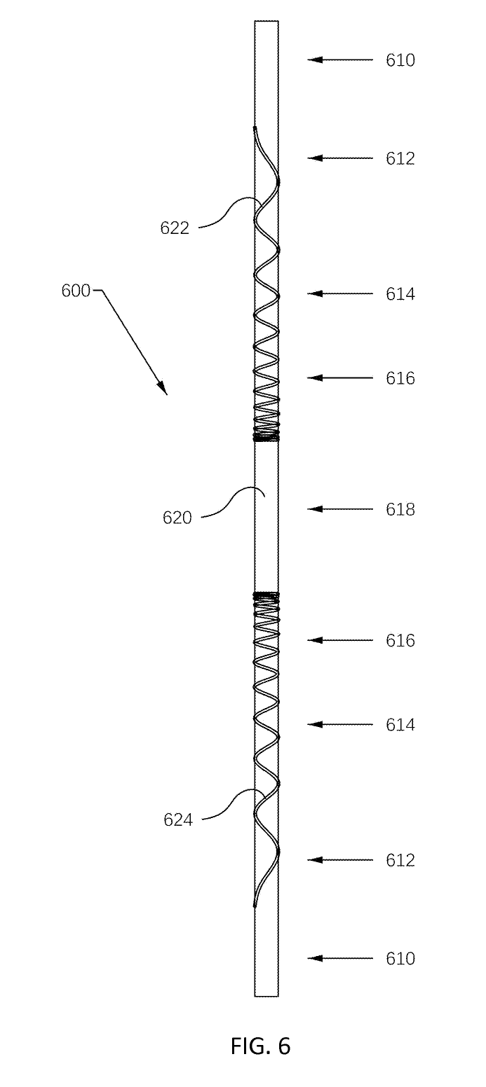

FIG. 6 is a diagram of another embodiment of an optic filament 600 that has been conditioned to emit light from specific regions of its lateral surface and is configured to accept light from a light source at both ends. Optic filament 600 includes a first strand 622 having a uniform thickness, fused to the surface of an optic fiber 620. In one embodiment, first strand 622 is made of an opaque material. For example, first stand 622 can be made of a white-colored acrylic resin or acrylate polymer if optic fiber 620 is made of a plastic material. In another example, first strand 622 can be made of milk glass if optic fiber 620 is made of a glass material. In another embodiment, first strand 622 is made of a transparent material that has an index of refraction that is different than the index of refraction of optic fiber 620. For example, if optic fiber 620 is made of a plastic material, first strand 622 may be made of a transparent plastic material with a different density and index of refraction than the plastic of optic fiber 620. In another example, if optic fiber 620 is made of a glass material, first strand 622 can be made of glass doped with a metal. First strand 622 wraps around the circumference of optic fiber 620 in a spiral with a pitch that varies. The pitch of the spiral formed by first strand 622 is coarse (i.e., further apart) in a region 612 near the end of optic fiber 620 and becomes increasingly finer (i.e., closer together) in regions 614 and 616 toward the middle of optic fiber 620 (as distance increases from the ends). First strand 622 ends before it reaches a middle region 618 of optic fiber 620. Optic filament 600 also includes a second strand 624, having a uniform thickness, fused to the surface of optic filament 600. Second strand 624 is formed of the same material as first strand 622. Second strand 624 wraps around the circumference of optic fiber 620 in a spiral with a pitch that varies. The pitch of the spiral formed by second strand 624 is fine in a region 616 near middle region 618 of optic fiber 620 and becomes increasingly coarse in regions 414 and 412 toward the end of optic fiber 620. Optic filament 600 also includes end regions 610 and middle region 618 that are untreated. When light is input into the ends of optic filament 600, light is emitted from treated regions 612, 614, and 616 of optic filament 600 at a substantially uniform luminous flux. The untreated middle region 618 internally reflects any light that reaches it after traveling from the ends of optic filament 600.

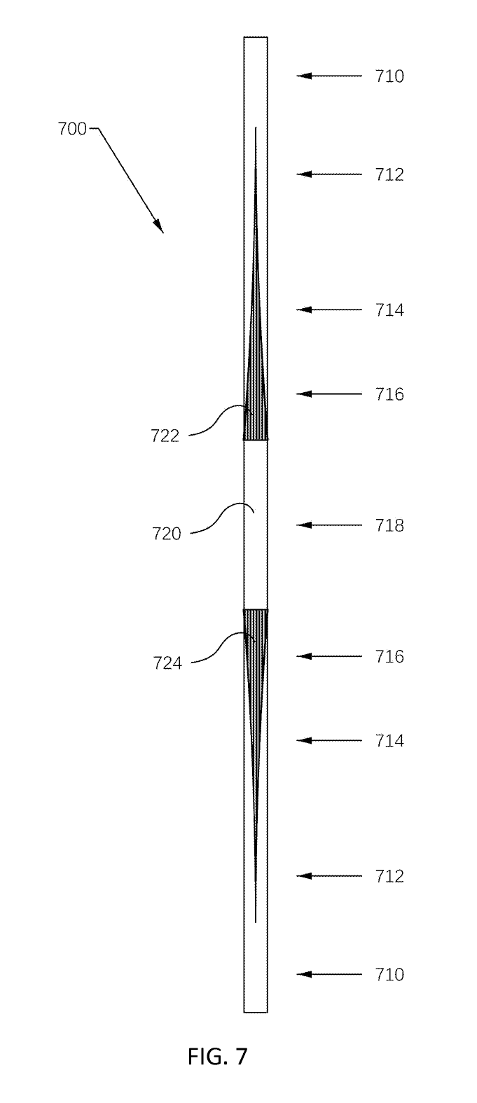

FIG. 7 is a diagram of another embodiment of an optic filament 700 that has been conditioned to emit light from specific regions of its lateral surface and is configured to accept light from a light source at both ends. Optic filament 700 includes a first strand 722 of material fused to the surface of an optic fiber 720. In one embodiment, first strand 722 is made of an opaque material. In another embodiment, first strand 722 is made of a transparent material having an index of refraction that is different than the index of refraction of optic fiber 720. First strand 722 can be made of the same types of materials as first strand 622 in the FIG. 6 embodiment. First strand 722 is fused to the surface of optic fiber 720 along the longitudinal axis of optic fiber 720. The thickness (i.e., cross-sectional area) of first strand 722 varies along its length, with the thinnest portion of first strand 722 being in a region 712 near the end of optic fiber 720. The thickness of first strand 722 increases along the length of optic fiber 720 towards a middle region 718. The thickest portion of first strand 722 is in a region 716 near middle region 718. Optic filament 700 also includes a second strand 724 of material fused to the surface of optic fiber 720. Second strand 724 is made of the same material as first strand 722. Second strand 724 is fused to the surface of optic fiber 720 along the longitudinal axis of optic fiber 720. The thickness (i.e., cross-sectional area) of second strand 724 varies along its length, with the thinnest portion of second strand 724 being in a region 712 near the end of optic fiber 720. The thickness of second strand 724 increases along the length of optic fiber 720 towards middle region 718. The thickest portion of second strand 724 is in a region 716 near middle region 718. Although the FIG. 7 embodiment includes two strands 722, 724, other numbers of strands are within the scope of the invention. Optic filament 700 also includes end regions 710 and middle region 718 that are untreated. When light is input into the ends of optic filament 700, light is emitted from treated regions 712, 714, and 716 of optic filament 700 at a substantially uniform luminous flux. The untreated middle region 718 internally reflects any light that reaches it after traveling from the ends of optic filament 700.

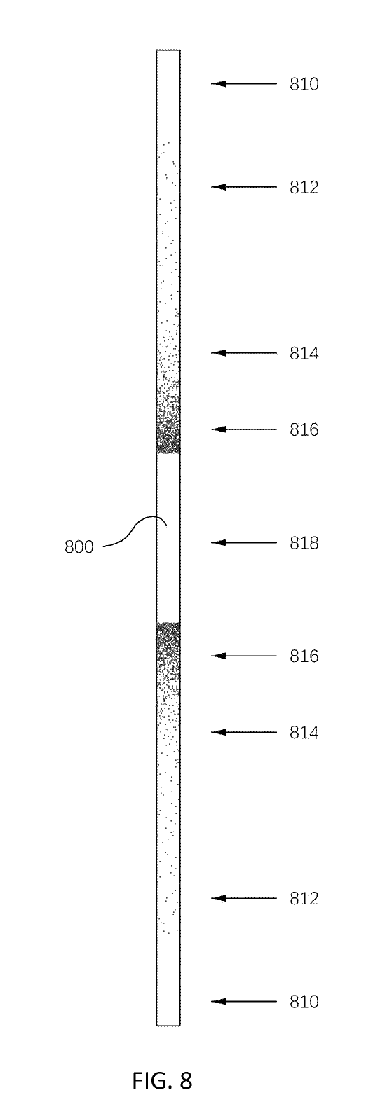

FIG. 8 is a diagram of another embodiment of an optic filament 800 that has been conditioned to emit light from specific regions of its lateral surface and is configured to accept light from a light source at both ends. Optic filament 800 includes a plurality of areas of cavitation, each area containing a plurality of cavities. Each cavity is a “bubble” that is under the surface of optic filament 800. In one embodiment, a finely focused laser applied to optic filament 800 created the plurality of areas of cavitation in the material of optic filament 800. The amount of cavitation in regions 812 near the ends of optic filament 800 is sparse and becomes denser in regions 814 and 816. The amount of cavitation in densest in regions 816 near a middle region 818 of optic filament 800. Optic filament 800 also includes end regions 810 and middle region 818 that are untreated. When light is input into the ends of optic filament 800, light is emitted from treated regions 812, 814, and 816 of optic filament 800 at a substantially uniform luminous flux. The untreated middle region 818 internally reflects any light that reaches it after traveling from the ends of optic filament 800.

In another embodiment, an optic filament may be treated by applying a phosphor powder material mixed in an optically clear adhesive solution. In this embodiment, LEDs whose peak emission spectra fall within the blue or violet wavelengths would provide the light entering the filament. The light interacts with the phosphors applied to the filament. The resulting phosphor excitation produces a white light that can be tuned to a desired color temperature. The phosphor application would be sprayed on at varying thicknesses or density along the length of the treated regions of the optic filament to produce the desired light intensity.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A illumination device comprising:
a plurality of optical fibers, each of the plurality of optical fibers having at least one lateral surface region configured to emit light of substantially uniform luminous flux;
at least one light emitting diode configured to direct light into an end of each of the plurality of optical fibers;
a platform coupled to the at least one light emitting diode; and
a circuit configured to supply a direct current power signal to the at least one light emitting diode.

2. The illumination device of claim 1, further comprising a second light emitting diode configured to direct light into a second end of each of the plurality of optical fibers.

3. The illumination device of claim 1, wherein each of the plurality of optical fibers has been treated with a mechanical process to cause the optical fiber to emit light from the at least one lateral surface region of the optical fiber.

4. The illumination device of claim 1, wherein the at least one lateral surface region includes at least one longitudinal groove parallel to the axis of the optical fiber, the at least one longitudinal groove having a varying depth.

5. The illumination device of claim 1, wherein the at least one lateral surface region includes a spiral groove having a varying pitch.

6. The illumination device of claim 1, wherein the at least one lateral surface region includes a groove perpendicular to the axis of the optical fiber, the groove having a varying pitch.

7. The illumination device of claim 1, wherein each of the plurality of optical fibers has been treated with a chemical process to cause the optical fiber to emit light from the at least one lateral surface region of the optical fiber.

8. The illumination device of claim 7, wherein the chemical process is a liquid chemical bath.

9. The illumination device of claim 7, wherein the chemical process is an exposure to a chemical gas.

10. The illumination device of claim 1, wherein the at least one lateral surface region includes droplets of an optically transmissive material on the surface of the optical fiber to cause the optical fiber to emit light from the at least one lateral surface region of the optical fiber.

11. The illumination device of claim 1, wherein the at least one lateral surface region includes at least one strand of optical material fused to the surface of the optical fiber.

12. The illumination device of claim 11, wherein the at least one strand of optical material is opaque.

13. The illumination device of claim 11, wherein the at least one strand of optical material is transparent and has an index of refraction that is different than the index of refraction of the optical fiber.

14. The illumination device of claim 11, wherein the at least one strand of optical material wraps around a circumference of the optical fiber in a spiral with a variable pitch.

15. The illumination device of claim 11, wherein the at least one strand of optical material has a variable cross-sectional area.

16. The illumination device of claim 1, wherein the at least one lateral surface region includes a plurality of cavities in the optical fiber.

17. The illumination device of claim 1, wherein the at least one lateral surface region has a phosphor coating on the surface of the optical fiber.

18. The illumination device of claim 1, further comprising a housing coupled to the platform, the housing configured to enclose the plurality of optical fibers and the at least one light emitting diode, and further configured to be uncoupled from the platform.

19. The illumination device of claim 1, wherein each of the plurality of optical fibers has a diameter less than or equal to approximately three millimeters.

20. The illumination device of claim 1, wherein each of the plurality of optical fibers has a length of at least approximately eight centimeters.

21. The illumination device of claim 20, wherein the at least one lateral surface region has a length of at least approximately twelve centimeters.

22. The illumination device of claim 1, further comprising a filament support configured to secure the plurality of optical fibers in a predetermined arrangement.

23. The illumination device of claim 1, wherein each of the plurality of optical fibers includes at least one surface region that is configured to not emit light.

24. An illumination device comprising:
a plurality of optical fibers, each of the plurality of optical fibers including at least one treated region configured to emit light of substantially uniform luminous flux;
at least one solid-state light source configured to direct light into an end of each of the plurality of optical fibers;
a platform coupled to the at least one solid-state light source; and
a circuit configured to supply a direct current power signal to the at least one solid-state light source.

25. The illumination device of claim 24, further comprising a second solid-state light source configured to direct light into a second end of each of the plurality of optical fibers.

26. The illumination device of claim 24, wherein each of the plurality of optical fibers has been treated with a mechanical process to cause the optical fiber to emit light from the at least one treated region of the optical fiber.

27. The illumination device of claim 24, wherein the at least one treated region includes at least one longitudinal groove parallel to the axis of the optical fiber, the at least one longitudinal groove having a varying depth.

28. The illumination device of claim 24, wherein the at least one treated region includes a spiral groove having a varying pitch.

29. The illumination device of claim 24, wherein the at least one treated region includes a groove perpendicular to the axis of the optical fiber, the groove having a varying pitch.

30. The illumination device of claim 24, wherein each of the plurality of optical fibers has been treated with a chemical process to cause the optical fiber to emit light from the at least one treated region of the optical fiber.

31. The illumination device of claim 30, wherein the chemical process is a liquid chemical bath.

32. The illumination device of claim 30, wherein the chemical process is an exposure to a chemical gas.

33. The illumination device of claim 24, wherein the at least one treated region includes droplets of an optically transmissive material on the surface of the optical fiber to cause the optical fiber to emit light from the at least one treated region of the optical fiber.

34. The illumination device of claim 24, wherein the at least one treated region includes at least one strand of optical material fused to the surface of the optical fiber.

35. The illumination device of claim 34, wherein the at least one strand of optical material is opaque.

36. The illumination device of claim 34, wherein the at least one strand of optical material is transparent and has an index of refraction that is different than the index of refraction of the optical fiber.

37. The illumination device of claim 34, wherein the at least one strand of optical material wraps around a circumference of the optical fiber in a spiral with a variable pitch.

38. The illumination device of claim 34, wherein the at least one strand of optical material has a variable cross-sectional area.

39. The illumination device of claim 24, wherein the at least one treated region includes a plurality of cavities in the optical fiber.

40. The illumination device of claim 24, wherein the at least one treated region has a phosphor coating on the surface of the optical fiber.

41. The illumination device of claim 24, further comprising a housing coupled to the platform, the housing configured to enclose the plurality of optical fibers and the at least one solid-state light source, and further configured to be uncoupled from the platform.

42. The illumination device of claim 24, wherein each of the plurality of optical fibers has a diameter less than or equal to approximately three millimeters.

43. The illumination device of claim 24, wherein each of the plurality of optical fibers has a length of at least approximately eight centimeters.

44. The illumination device of claim 43, wherein the at least one treated region has a length of at least approximately twelve centimeters.

45. The illumination device of claim 24, further comprising a filament support configured to secure the plurality of optical fibers in a predetermined arrangement.

46. The illumination device of claim 24, wherein each of the plurality of optical fibers includes at least one surface region that is configured to not emit light.
